(19) United States
(12) Patent Application Publication
(10) Pub. No.: US 2011/0139183 A1
(43) Pub. Date: Jun. 16, 2011

(54) SYSTEM AND METHOD OF PREVENTING PATTERN COLLAPSE USING LOW SURFACE TENSION FLUID

(76) Inventors: Katrina Mikhaylichenko, San Jose, CA (US); Denis Syomin, Fremont, CA (US); Mark Wilcoxson, Fremont, CA (US)

(21) Appl. No.: 12/965,828

(22) Filed: Dec. 11, 2010

Related U.S. Application Data
(60) Provisional application No. 61/285,949, filed on Dec. 11, 2009.

(51) Int. Cl. B08B 3/00; B08B 7/04

(52) U.S. Cl. 134/18; 134/105

(57) ABSTRACT

A system for processing a wafer with a low surface tension liquid includes a low surface tension liquid source including a first heat source capable of heating the low surface tension liquid to not more than 25 degrees C. less than boiling point of the low surface tension liquid, a delivery mechanism for delivering the heated low surface tension liquid to an air/liquid interface region and a second heat source directed toward the air/liquid interface region, the second heat source capable of heating the air/liquid interface region to at least 2 degrees C. greater than the boiling point of the low surface tension liquid. A method for processing a wafer with a low surface tension liquid is also described.

### CROSS REFERENCE TO RELATED APPLICATIONS

This application claims priority from U.S. Provisional Patent Application No. 61/285,949, filed on Dec. 11, 2009 and entitled “SYSTEM AND METHOD OF CORRECTING PATTERN COLLAPSE USING LOW SURFACE TENSION FLUID,” which is incorporated herein by reference in its entirety for all purposes.

### BACKGROUND

The present invention relates generally to cleaning, rinsing and drying semiconductor wafers, and more particularly, to methods and systems for drying the semiconductor wafer after a wet rinse or clean process.

Critical dimensions of semiconductor devices are shrinking to 2× (i.e., about 20-30 nm) and 1×nm (i.e. less than about 20 nm) in both device width and/or device spacing. As the critical dimension gets smaller wet processing of high aspect ratio structures (e.g., greater than 5 to 1 aspect ratio of depth to width) becomes increasingly challenging. Structures become so delicate that wet processing of these structures required to prepare the state of the surface and/or to remove unwanted residues often causes damage. The damage can be mechanical due to forces from the flow field required for cleaning and rinsing, megasonics, jets and other particle removal techniques. Such damage often occurs on sparse patterns with small line geometries and is exhibited as broken lines and portions of missing lines.

FIG. 1 illustrates one example of damage on a relatively separated line structure 106. The line structure 106 rises above the surface 105 of the semiconductor wafer 101. Portions 102, 104 of the line structure 106 are broken away from the line structure. As a result, the line structure 106 is incomplete and has a gap 107. Portions 102, 104 may be broken away from the line structure 106 by relatively minor forces like a spray jet spraying a rinsing fluid or a liquid flowing across the surface of the wafer or megasonic energy applied to the liquid or the semiconductor wafer 101 by a transducer or other source.

FIG. 2A illustrates a sectional view of an example of ideal cluster 200 of closely spaced line structures 202-212, affected by damage due to surface tension while drying. FIG. 2B illustrates a top view of an example of ideal cluster 200 of closely spaced line structures 202-212, affected by damage due to surface tension while drying. The line structures 202-212 are also damaged while drying due to the surface tension of the drying liquid. As a result the lines structures 202-212 are touching together, on the top, in pairs and more. The line structures 202-212 are high aspect ratio line structures as they have a height H greater than about 5 times the width W. The line structures 202-212 have respective intervening spaces 214-222 between the line structures. The intervening spaces 214-222 also have a width substantially equal to width W of the line structures 202-212.

FIG. 2B illustrates an example of damage to the ideal cluster 200 of closely spaced line structures 202-212. As shown, the line structure pairs 202, 204 and 206, 208 and 210, 212 have been forced together and therefore the respective intervening spaces 214, 218 and 222 have been squeezed down to having a width approaching zero. As a zero width intervening space means the line structures are connected this can cause serious flaws and errors in subsequent operations and structures formed thereon.

Further, intervening spaces 216 and 220 have been spread apart such that they have a width approaching twice the desired width. As a excess width intervening space means the line structures are separated too far apart and this can cause serious flaws and errors in subsequent operations and structures formed thereon.

FIG. 2C is a perspective view of an ideal cluster 250 of closely spaced line structures 252-264. Damage can also be caused by surface tension related forces and can occur during drying. Liquid accumulated between high aspect ratio line structures 252-264 induces lateral forces F1, F2 that pull the line structures towards each other.

When a intervening space between two surfaces of opposing line structures reaches a critical value, the surfaces can adhere to each other due to a number of interfacial forces. Such damage typically occurs with dense high aspect ratio structures and is exhibited by top portion of structure elements sticking to each other as shown in FIG. 2C.

FIG. 2C shows a hydrophilic surface and a concave surface of the liquid in the intervening spaces 274-284 between line structures 252-264. A pressure difference across the curved interface is given by the following LaPlace equation:

$$Δ P = \frac{γ}{R} ,$$

γ—surface tension; R—Radius of curvature of the surface of the liquid

R—radius of curvature of the surface of the liquid is given by:

$$R = \frac{d}{2 cos Θ} ,$$

Θ—the contact angle

Forces acting on the pattern of structure elements include:

F1—due to variations in evaporation rate causing variation in meniscus height

F2—due to variations in line structure spacing causing variation in radius of curvature.

The force F1 can pull the respective line structures 256, 258 together. Similarly, force F2 can push lie structures 258, 260 apart. The forces F1, F2 can cause the damage shown in FIGS. 1, 2A and 2B above.

In view of the foregoing, there is a need for a system and a method for reducing the surface tension of the liquid that contacts the line structures.

### SUMMARY

Broadly speaking, the present invention fills these needs by providing a system and a method for processing a wafer with a low surface tension liquid. It should be appreciated that the present invention can be implemented in numerous ways, including as a process, an apparatus, a system, computer readable media, or a device. Several inventive embodiments of the present invention are described below.

One embodiment provides a system for processing and drying a wafer with a low surface tension liquid includes a low surface tension liquid source including a first heat source capable of heating the low surface tension liquid to not more than 25 degrees C. less than boiling point of the low surface tension liquid, a delivery mechanism for delivering the heated low surface tension liquid to an air/liquid interface region and a second heat source directed toward the air/liquid interface region, the second heat source capable of heating the air/liquid interface region to at least 2 degrees C. greater than the boiling point of the low surface tension liquid.

The air/liquid interface region can be on a surface of a wafer. The system can also include an actuator to move the air/liquid interface region across the surface of the wafer. The second heat source can be directed to at least one of a front surface and a back surface of the wafer. The second heat source can include both a front heat source directed toward a front surface of the wafer and a back side heat source directed toward the back surface of the wafer.

The delivery mechanism for delivering the heated low surface tension liquid to an air/liquid interface region can include a reservoir containing a quantity of the heated low surface tension liquid and wherein the air/liquid interface region is proximate to the surface of the quantity of the heated low surface tension liquid.

The delivery mechanism for delivering the heated low surface tension liquid to an air/liquid interface region can include a nozzle directed toward the air/liquid interface region for spraying the heated low surface tension liquid on the surface of the wafer.

The delivery mechanism for delivering the heated low surface tension liquid to the air/liquid interface region can include a proximity head capable of forming a meniscus between a proximity head surface and a surface of the wafer wherein the air/liquid interface region is a trailing edge of the meniscus.

Another embodiment provides a method of rinsing a surface with a low surface tension liquid including heating the low surface tension liquid to a temperature not more than 25 degrees C. less than boiling point of the low surface tension liquid; delivering the heated low surface tension liquid to an air/liquid interface region; and heating the air/liquid interface region to at least 2 degrees C. greater than the boiling point of the low surface tension liquid.

The air/liquid interface region can be on the surface of a wafer. The method can also include moving the air/liquid interface region across the surface of the wafer. Heating the air/liquid interface region to at least 2 degrees C. greater than the boiling point of the low surface tension liquid can include heating at least one of a front surface and a back surface of the wafer. Heating the air/liquid interface region to at least 2 degrees C. greater than the boiling point of the low surface tension liquid can include heating a front surface and a back surface of the wafer.

Delivering the heated low surface tension liquid to an air/liquid interface region can include submerging the wafer in a reservoir containing a quantity of the heated low surface tension liquid and wherein the air/liquid interface region is proximate to the surface of the quantity of the heated low surface tension liquid.

Delivering the heated low surface tension liquid to an air/liquid interface region can include a nozzle directed toward the air/liquid interface region for spraying the heated low surface tension liquid on the surface of the wafer.

Delivering the heated low surface tension liquid to the air/liquid interface region can include forming a meniscus between a proximity head surface and a surface of the wafer wherein the air/liquid interface region is a trailing edge of the meniscus.

Yet another embodiment provides a system for processing and drying a wafer with a low surface tension liquid including a low surface tension liquid source including a first heat source capable of heating the low surface tension liquid to not more than 25 degrees C. less than boiling point of the low surface tension liquid, a delivery mechanism for delivering the heated low surface tension liquid to an air/liquid interface region wherein the air/liquid interface region is on a surface of a wafer, a second heat source directed toward the air/liquid interface region, the second heat source capable of heating the air/liquid interface region to at least 2 degrees C. greater than the boiling point of the low surface tension liquid, wherein the second heat source is directed to at least one of a front surface and a back surface of the wafer, an actuator capable of moving the air/liquid interface region across the surface of the wafer.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 illustrates one example of damage on a relatively separated line structure.

FIG. 2A illustrates a sectional view of an example of ideal cluster of closely spaced line structures, affected by damage due to surface tension while drying.

FIG. 2B illustrates a top view of an example of ideal cluster of closely spaced line structures, affected by damage due to surface tension while drying.

FIG. 2C is a perspective view of an ideal cluster of closely spaced line structures.

FIG. 3 illustrates line structures bent by the forces F1, F2, in accordance with an embodiment of the present invention.

FIGS. 4A and 4B are a low surface tension liquid cleaning system, in accordance with an embodiment of the present invention.

FIG. 5 is a flowchart diagram that illustrates the method operations performed in withdrawing a wafer from a low surface tension liquid cleaning fluid, in accordance with one embodiment of the present invention.

FIG. 6A is a low surface tension drying/cleaning fluid nozzle system, in accordance with an embodiment of the present invention.

FIG. 6B is a flowchart diagram that illustrates the method operations performed in drying/cleaning a wafer with a nozzle, in accordance with one embodiment of the present invention.

FIG. 7A is a low surface tension drying/cleaning fluid proximity head system, in accordance with an embodiment of the present invention.

FIG. 7B is a flowchart diagram that illustrates the method operations performed in drying/cleaning a wafer with a proximity head, in accordance with one embodiment of the present invention.

FIG. 8 is a block diagram of an integrated system including one or more of the low surface tension drying/cleaning fluid systems, in accordance with an embodiment of the present invention.

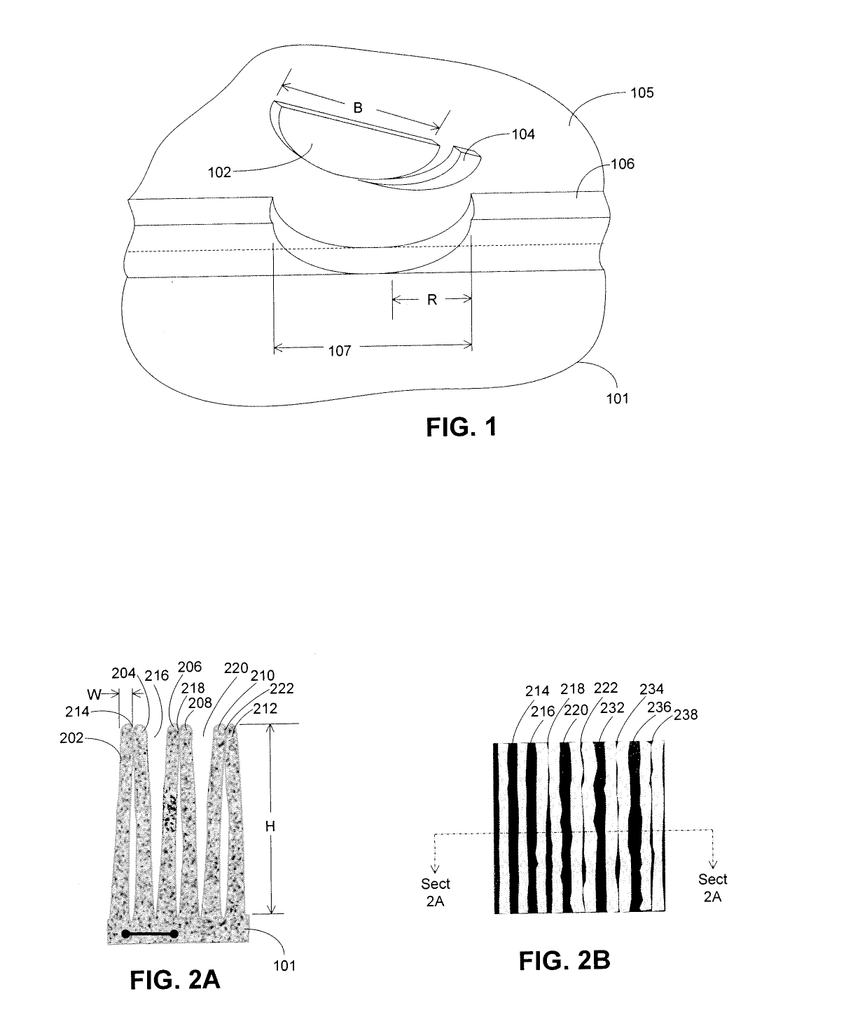

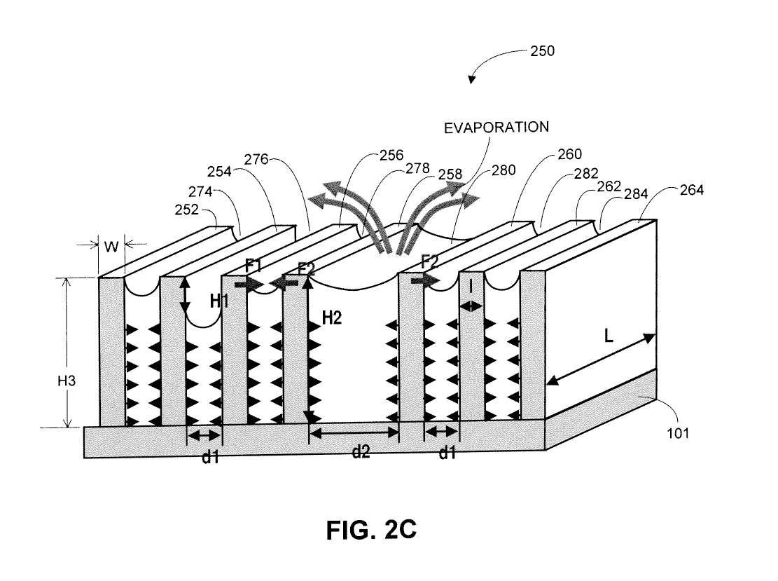

### DETAILED DESCRIPTION

Several exemplary embodiments for low surface tension fluid cleaning and rinsing systems, methods and apparatus will now be described. It will be apparent to those skilled in the art that the present invention may be practiced without some or all of the specific details set forth herein.

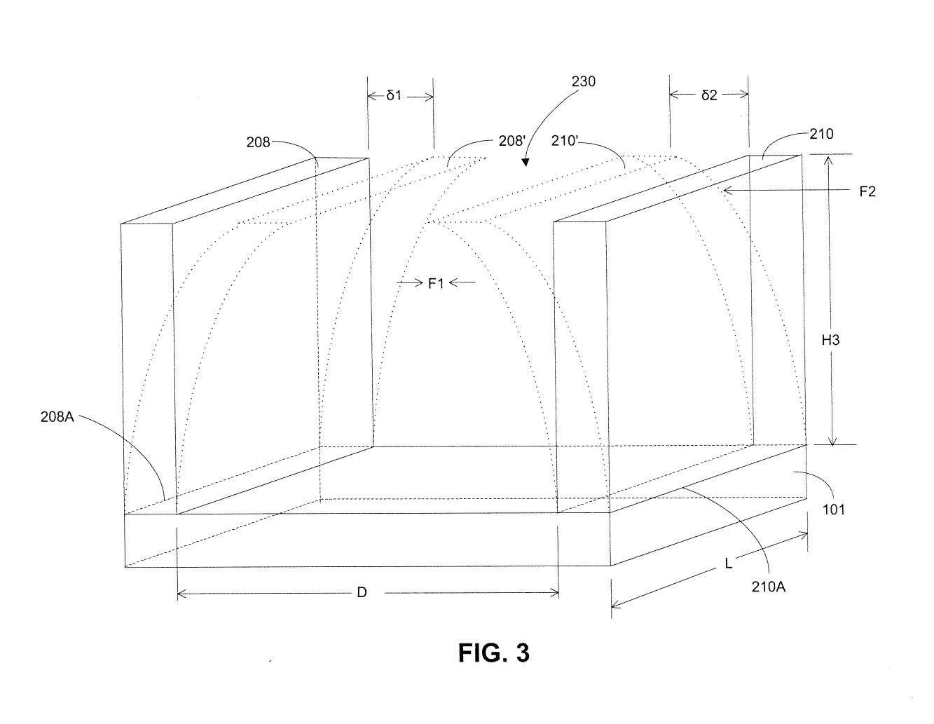

FIG. 3 illustrates line structures 208, 210 bent by the forces F1, F2, in accordance with an embodiment of the present invention. The line structures 208, 210 act as a cantilever with one side 208A, 210A fixed to the substrate 101 and the opposing end in free space. Surface tension forces F1, F2 cause the line structure 208 to deflect inward toward the other line structure 210 as shown in phantom 208′, 210′.

Pattern collapse occurs when the respective lateral deflection or sway value δ1, δ2, of the line structures 208, 210 is larger than half of the distance D between the structure elements.

The forces acting on the structure elements can be a uniform pressure loading and/or a single pulling force at the free end. Lateral deflection δ1, δ2, of the line structures 208, 210 for uniform pressure loading can be determined as:

$$δ = \frac{3}{2} \frac{P}{E} {HA}^{3}$$

E—Young's module

A—aspect ratio, H/W

The issue of pattern collapse in drying becomes a significant obstacle for the 2× device node and smaller (e.g., 1×) generations of devices. The dimensions and rigidity of the devices (e.g., line structures) coupled with the physical properties of drying liquids reach fundamental limit after which the pattern collapse can not be avoided.

In some instances such as post STI etch and post STI hard mask open clean, the pattern collapse in drying is often so severe that the pattern collapse precludes the use of most conventional wet cleaning techniques for residue and contamination removal. However, the absence of wet clean leads to significant yield loss. As a result, much more complex, expensive approaches such as supercritical CO2 are used. Such approaches are much more expensive and more difficult to perform.

### Low Surface Tension Liquid

One method of minimizing and even substantially eliminating pattern collapse in drying uses a low surface tension liquid. Heating the liquid can further aid in the eliminating pattern collapse during drying. Heating can be accomplished by one or more infra-red (IR) lamps.

One method of depositing of low surface tension fluid onto a wafer such as dipping the wafer in the low surface tension fluid such as a vertical reservoir. One alternative the wafer can be substantially horizontal and a thin fluid film deposited from nozzle, air brush or by running low surface tension fluid through proximity head with a meniscus. Another alternative has a substantially vertical wafer orientation and a thin film of fluid deposited from nozzle, air brush etc.

The low surface tension fluid or liquid can be quickly heated to temperatures close to boiling point of the liquid and the wafer to temperatures above the boiling point before the liquid is evaporated from between the line structures. Radiant heating such as by an infrared (IR) lamp. Alternatively, additional heating sources for reservoirs with low surface tension fluid.

Some examples of low surface tension liquids and fluids include but are not limited to isopropyl alcohol (IPA), partially fluorinated ethers (e.g. HFE7100, HFE7200 from 3M Corporation), or fully fluorinated ethers (e.g., FC-84; FC-72 from 3M Corporation). Relative surface tensions of some liquids:

| | |
|---|---|
| DIW (de-ionized water) | γ = 72 dynes/cm at 25 C. |
| IPA | γ = 22 dynes/cm at 25 C. |
| HFE7100 | γ = 14 dynes/cm at 25 C. |

Any cleaning fluid having a surface tension of less than about γ=22 dynes/cm at 25 C could also be used.

A carbon emitter (medium wave IR) lamp from Heraeus is an example of a suitable heating source Lamp output 1200 W over 1700 mm length (7 watt/mm) Light density at sample surface ˜14 W/cm2. Maximum output at 2.5 um wavelength. Other suitable heat sources could also be used.

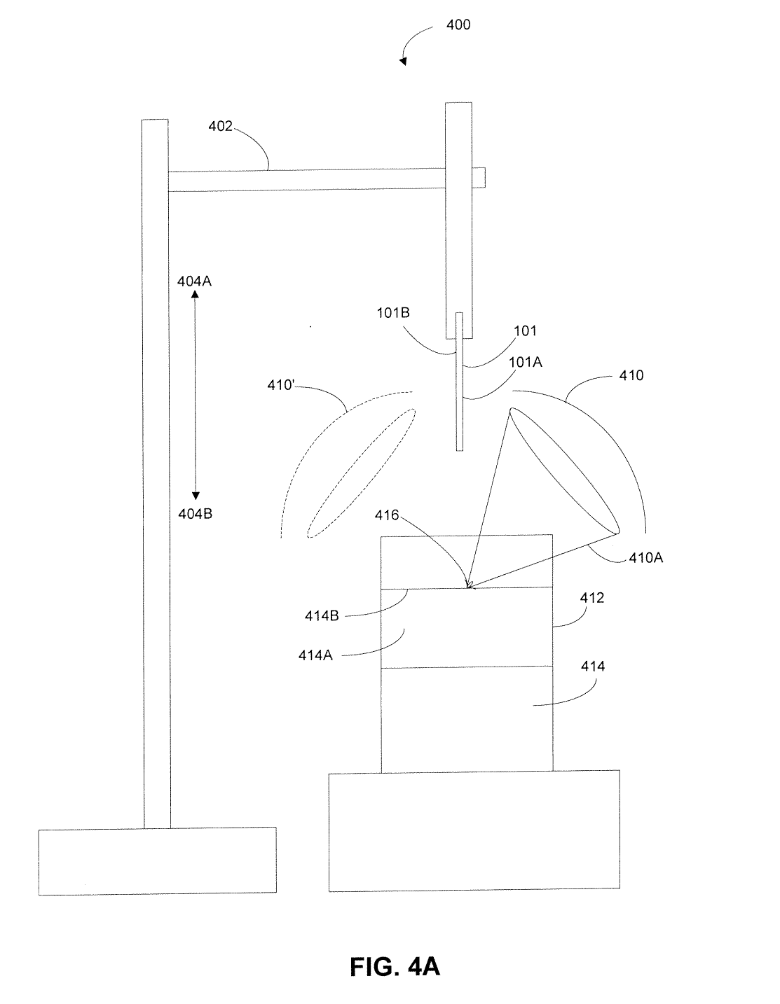

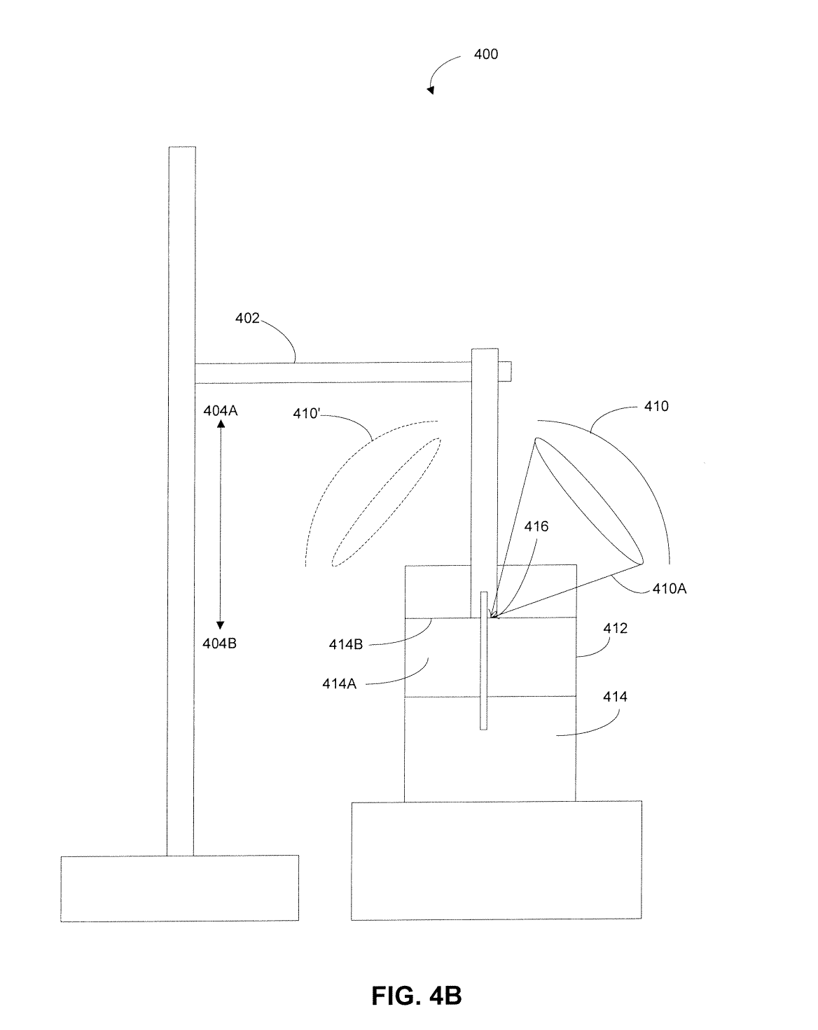

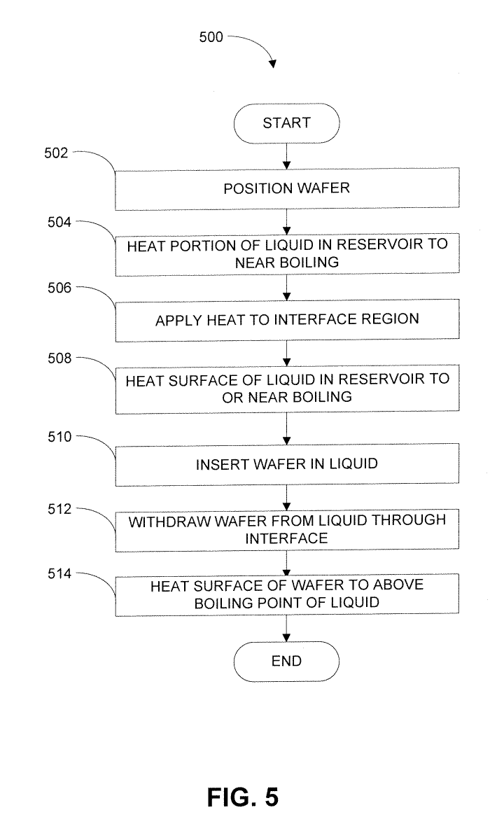

FIGS. 4A and 4B are a low surface tension liquid cleaning system 400, in accordance with an embodiment of the present invention. FIG. 5 is a flowchart diagram that illustrates the method operations 500 performed in withdrawing a wafer 101 from a low surface tension liquid cleaning fluid, in accordance with one embodiment of the present invention. The operations illustrated herein are by way of example, as it should be understood that some operations may have sub-operations and in other instances, certain operations described herein may not be included in the illustrated operations. With this in mind, the method and operations 480 will now be described.

The low surface tension liquid cleaning system 400 includes a reservoir 412 with low surface tension fluid 414, a wafer 101 positioned substantially vertically relative to the reservoir in an operation 502. The wafer 101 can move substantially vertically in directions 404A, 404B through the liquid/air interface 416 at the surface of the low surface tension fluid 414 as described below. An actuator 402 can move the wafer 101 through the liquid/air interface 416 (i.e., the region/line where the wafer enters or leaves the fluid) in directions 404A, 404B.

In an operation 504, the low surface tension fluid 414 is heated to close to its boiling point in the reservoir. By way of example, the low surface tension fluid 414 is heated to within not less than about 5-10 degrees less than boiling point in at least the top portion of the fluid in the reservoir 414. Using HFE7100 as an example, HFE7100 has a boiling point of 61 C and the top portion 414A of the fluid in the reservoir 412 is still in liquid form and is at about 50-55 C.

In an operation 506, one or more heat sources 410, 410′ applies heat 410A to the surface 101A, 101B of the substrate and top surface 414B of the fluid substantially at the interface region 416. The heating sources 410, 410′ can be a lamp with radiation frequency and wavelength that is well absorbed by the fluid 414.

In an operation 508, the surface 414B of the fluid 414 can be heated to or near boiling point of the fluid. Vigorous boiling can be on surface 414B of the fluid.

In an operation 510, the wafer 101 is inserted into the fluid 414 as shown in FIG. 4B. When the wafer 101 is transferred into the reservoir 412 the wafer may be wet from a previous cleaning/rinsing step and any liquid remaining on the wafer from the previous cleaning/rinsing step will be miscible with the low surface tension fluid 414.

In an operation 512, the wafer 101 is drawn through the wet-dry interface region 416 in direction 404A at a speed of about 0.5-10 mm/sec. In operation 512 the wafer 101 is withdrawn from the surface 414B of the fluid, through the wet-dry interface 416.

As a first portion of the wafer 101 passes through the wet-dry interface 416, the first portion of the wafer surface 101A, 101B is heated to a temperature significantly above the boiling point of the fluid (e.g., at least 2 degrees higher than the boiling point e.g., greater than 51 C for HFE7100) in an operation 514. In an operation 516, the fluid 414 achieves a boiling point temperature within about 0 to about 3 seconds from the first portion of the wafer 101 being withdrawn from the surface 414B of the cleaning fluid 414 and the method and operations can end.

It should be understood that the heat sources 410, 410′ can be directed at either of a front side 101A (i.e., the side with structure elements and devices formed thereon) or back side 101B (i.e., the side opposite the front side) or both sides of the wafer 101. The heat sources 410, 410′ can be directed directly at the interface 416 of the fluid and the surface of the wafer 101 and on a portion of the liquid 414 so as to heat the liquid proximate to the interface 416. One or both of the heat sources 410, 410′ can be directed at a portion of the wafer 101 extending above and/or below the interface 416.

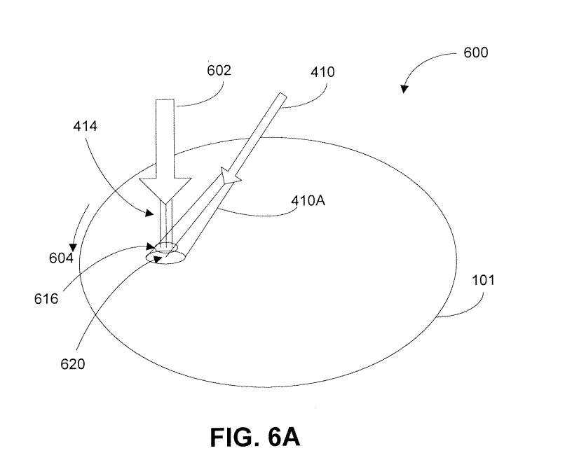

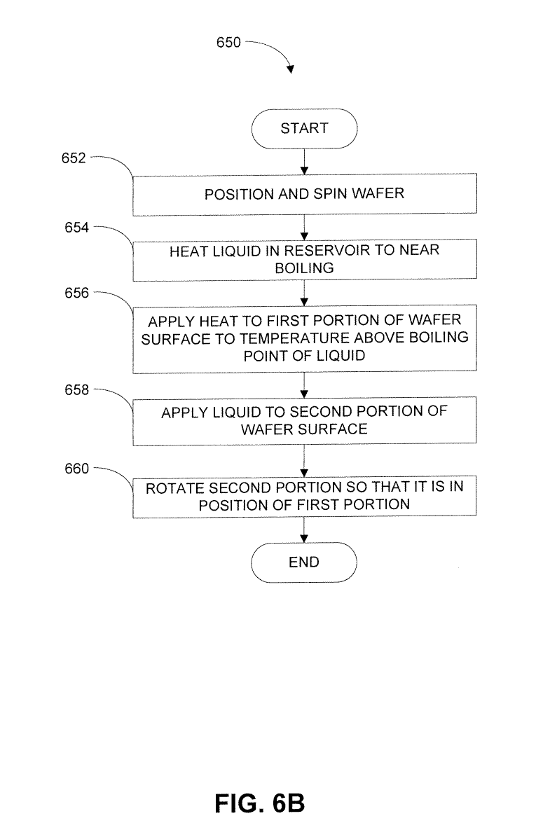

FIG. 6A is a low surface tension drying/cleaning fluid nozzle system 600, in accordance with an embodiment of the present invention. FIG. 6B is a flowchart diagram that illustrates the method operations 650 performed in drying/cleaning a wafer 101 with a nozzle, in accordance with one embodiment of the present invention. The operations illustrated herein are by way of example, as it should be understood that some operations may have sub-operations and in other instances, certain operations described herein may not be included in the illustrated operations. With this in mind, the method and operations 650 will now be described.

The low surface tension drying/cleaning fluid nozzle system 600 includes a nozzle 602. The wafer 101 can be rotated or spun in direction 604. The wafer 101 can be a horizontal or vertical or some combination orientation.

In an operation 652, the wafer is spun in direction 604. In an operation 654 the liquid is heated to near boiling point as described above in operation 504. The liquid is heated before being spread or sprayed on the wafer. The liquid can be heated in a source such as a reservoir or other liquid supply source.

In an operation 656, a first portion 620 of the wafer surface is heated by the heat source 410 to a temperature above the boiling point of the liquid. In operation, 658, the heated liquid 414 is spread or sprayed on a second portion surface 616 of the wafer 101 near the heated portion 620.

In an operation 660, the second portion surface 616 is rotated into the first portion 620 and the liquid 414 is boiled away from the surface of the wafer 101. The method operations continue until the entire surface of the wafer has been rinsed/cleaned and the method operations can end. It should be understood that the locations of the first portion 620 and the second portion 616 of the surface can be moved or selected as desired. The low surface tension fluid is used and a heat source can be directed to one or both sides of the wafer 101 at or just after the location the low surface tension fluid is deposited on the surface of the wafer.

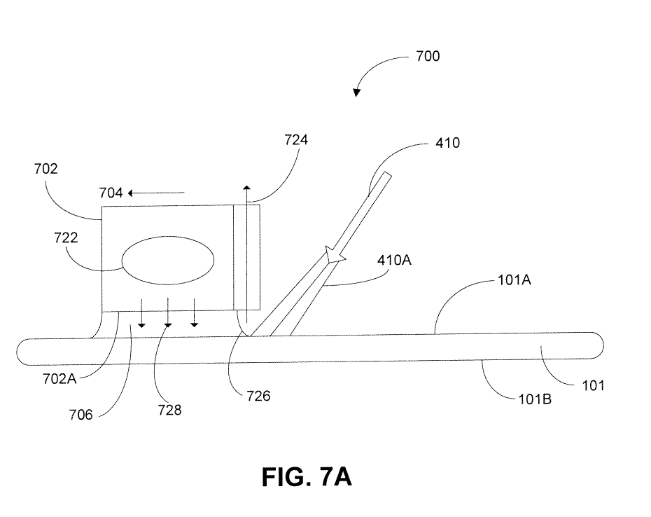

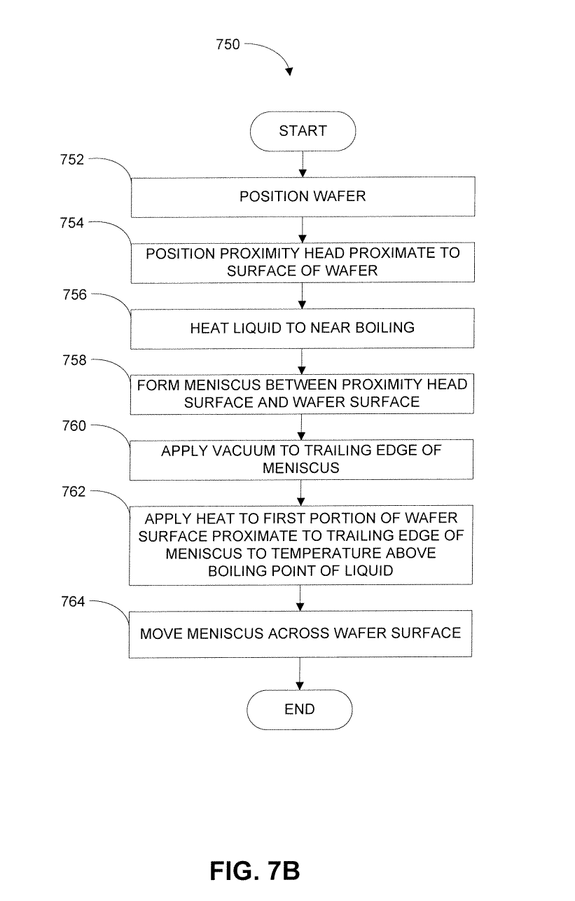

FIG. 7A is a low surface tension drying/cleaning fluid proximity head system 700, in accordance with an embodiment of the present invention. FIG. 7B is a flowchart diagram that illustrates the method operations 750 performed in drying/cleaning a wafer 101 with a proximity head, in accordance with one embodiment of the present invention. The operations illustrated herein are by way of example, as it should be understood that some operations may have sub-operations and in other instances, certain operations described herein may not be included in the illustrated operations. With this in mind, the method and operations 750 will now be described.

The low surface tension drying/cleaning fluid proximity head system 700 includes one or more proximity heads 702 that can form one or more liquid meniscus 706 between the proximity head surface 702A and one or both surfaces 101A, 101B of the wafer 101. The wafer 101 can be in any orientation (e.g., vertical, horizontal or combinations thereof). The heat source 410 is directed to one or both sides 101A, 101B of the wafer 101 at or very near a trailing edge 726 of the meniscus 706. The trailing edge 726 being on the edge of the meniscus 706 the surface 101A of the wafer is pulling away from as the proximity head 702 is moved in direction 704 relative to the surface 101A of the wafer 101. The proximity head 702 can include a heater portion 722 for heating the low surface tension drying/cleaning fluid. Alternatively, the low surface tension drying/cleaning fluid can be heated externally from the proximity head 702 such as in a source or reservoir as described above.

Additional details of the proximity head 702 are described in commonly assigned and co-pending U.S. patent application Ser. No. 10/816,487, filed on Mar. 31, 2004, and entitled “Proximity Head Heating Method and Apparatus”, which is incorporated by reference herein for all purposes. Moreover, the embodiments described herein are related to the following patent applications. Specifically, the following related applications are hereby incorporated by reference in their entirety: 1) U.S. patent application Ser. No. 10/330,843, entitled, “Meniscus, Vacuum, IPA Vapor, Drying Manifold,” filed on Dec. 24, 2002, 2) U.S. patent application Ser. No. 10/330,897, entitled, “System for Substrate Processing with Meniscus, Vacuum, IPA Vapor, Drying Manifold,” filed on Dec. 24, 2002, 3) U.S. patent application Ser. No. 10/404,270, entitled, “Vertical Proximity Processor,” filed on Mar. 31, 2003, 4) U.S. patent application Ser. No. 10/404,692, entitled, “Methods and Systems for Processing a Substrate Using a Dynamic Liquid Meniscus,” filed on Mar. 31, 2003, 5) U.S. patent application Ser. No. 10/603,427, entitled, “Methods and Systems for Processing a Bevel Edge a Substrate Using a Dynamic Liquid Meniscus,” filed on Jun. 24, 2003, 6) U.S. patent application Ser. No. 10/606,022, entitled, “System and Method for Integrating In-Situ Metrology Within a Wafer Process,” filed on Jun. 24, 2003, 7) U.S. patent application Ser. No. 10/611,140, entitled, “Method and Apparatus for Cleaning a Substrate Using Megasonic Power,” filed on Jun. 30, 2003, and 8) U.S. patent application Ser. No. 10/742,303, entitled, “Proximity Brush Unit Apparatus and Method,” filed on Dec. 18, 2003.

In an operation 752, the wafer 101 is moved into position. In operation 754, the proximity head 702 is moved into position relative to surface 101A of the wafer 101.

In an operation 756, the low surface tension drying/cleaning fluid is heated to near boiling point. The low surface tension drying/cleaning fluid can be heated inside or external from the proximity head 702.

In an operation 758, the heated low surface tension drying/cleaning fluid is injected into the space between the proximity head surface 702A and the wafer surface 101A to form a meniscus 706. In an operation 760, vacuum draws fluid from trailing edge 726 of the meniscus 706. In an operation 762, heat 410A is applied to a first portion of wafer surface 101A proximate to trailing edge 726 of meniscus 706 to temperature above boiling point of liquid. By way of example, DIW can be heated to greater than about 70 degrees C. and less than boiling (e.g. 100 degrees C.). In one embodiment, the DIW is heated to about 90 degrees C. The surface tension decrease with temperature is relatively small (e.g., from about 72 dynes/cm at 25 degrees C. to about 64 dynes/cm at 75 degrees C. for DIW and from about 22 dynes/cm to about 17 dynes/cm for IPA). While the decrease in surface tension is not great, the relatively faster evaporation rate of the heated (e.g., greater than about 70 degrees C.) DIW substantially reduces the pattern damage.

In an operation 764, the meniscus 706 is moved across the surface 101A of the wafer 101 to clean, rinse, dry the surface of the wafer. The wafer 101 can move relative to the proximity head 702 either laterally or rotationally until the entire surface 101A of the wafer has been processed and the method operations can end.

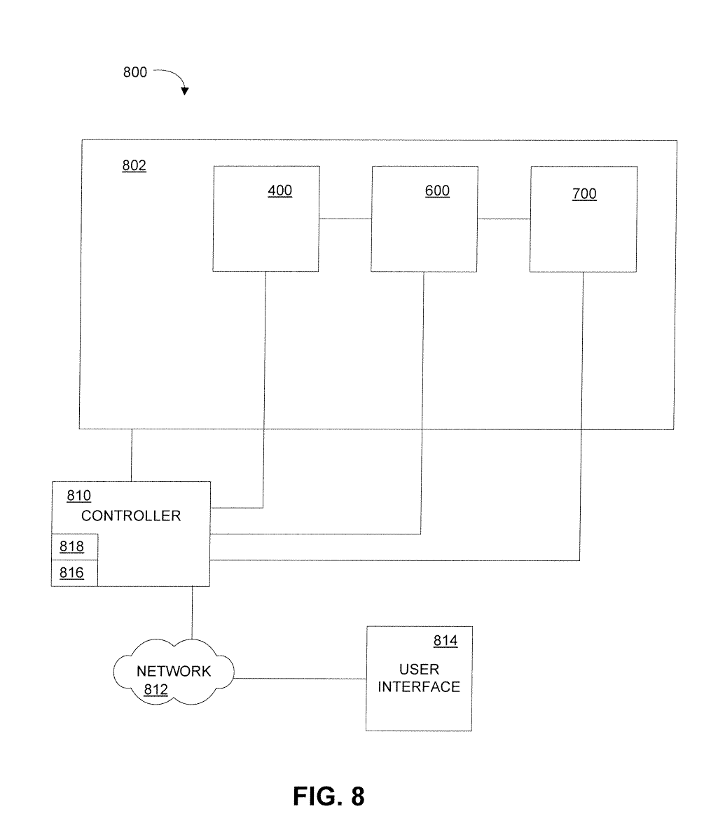

FIG. 8 is a block diagram of an integrated system 800 including one or more of the low surface tension drying/cleaning fluid systems 400, 600, 700, in accordance with an embodiment of the present invention. The integrated system 800 includes the one or more of the low surface tension drying/cleaning fluid systems 400, 600, 700, and an integrated system controller 810 coupled to the low surface tension drying/cleaning fluid systems. The integrated system controller 810 includes or is coupled to (e.g., via a wired or wireless network 812) a user interface 814. The user interface 814 provides user readable outputs and indications and can receive user inputs and provides user access to the integrated system controller 810.

The integrated system controller 810 can include a special purpose computer or a general purpose computer. The integrated system controller 810 can execute computer programs and/or logic 816 to monitor, control and collect and store data 818 (e.g., performance history, analysis of performance or defects, operator logs, and history, etc.) for the systems 400, 600, 700. By way of example, the integrated system controller 810 can adjust the operations of the systems 400, 600, 700 and/or the components therein (e.g., the temperatures, flow rates, pressures, locations, movement, loading and unloading of the wafer 101, etc.) if data collected dictates an adjustment to the operation thereof.

In another embodiment, a wafer can be first exposed to a substantially wet cleaning chemical for the purpose of residue and contamination removal. The wafer is exposed for sufficient time to achieve effective residue removal. The residue and contamination removal chemicals can include but are not limited to HF, SC1, SC2, DSP solvent. The residue and contamination removal chemicals are rinsed away from the wafer with deionized water (DIW). A low surface tension fluid displaces the DIW and any residue of the chemicals. The low surface tension fluid dries the surface of the wafer. In one embodiment, an intermediate chemical may be required to achieve effective displacement as low surface tension liquid and DIW are not always miscible. Once the displacement is achieved, the wafer is dried as described in more detail above.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium and/or logic circuits. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for processing and drying a wafer with a low surface tension liquid compromising:
a low surface tension liquid source including a first heat source capable of heating the low surface tension liquid to not more than 25 degrees C. less than boiling point of the low surface tension liquid;
a delivery mechanism for delivering the heated low surface tension liquid to an air/liquid interface region; and
a second heat source directed toward the air/liquid interface region, the second heat source capable of heating the air/liquid interface region to at least 2 degrees C. greater than the boiling point of the low surface tension liquid.

2. The system of claim 1, wherein the air/liquid interface region is on a surface of a wafer.

3. The system of claim 2, further comprising an actuator to move the air/liquid interface region across the surface of the wafer.

4. The system of claim 2, wherein the second heat source is directed to at least one of a front surface and a back surface of the wafer.

5. The system of claim 2, wherein the second heat source includes a front heat source directed toward a front surface of the wafer and a back side heat source directed toward the back surface of the wafer.

6. The system of claim 2, wherein the delivery mechanism for delivering the heated low surface tension liquid to an air/liquid interface region includes a reservoir containing a quantity of the heated low surface tension liquid and wherein the air/liquid interface region is proximate to the surface of the quantity of the heated low surface tension liquid.

7. The system of claim 2, wherein the delivery mechanism for delivering the heated low surface tension liquid to an air/liquid interface region includes a nozzle directed toward the air/liquid interface region for spraying the heated low surface tension liquid on the surface of the wafer.

8. The system of claim 2, wherein the delivery mechanism for delivering the heated low surface tension liquid to the air/liquid interface region includes a proximity head capable of forming a meniscus between a proximity head surface and a surface of the wafer wherein the air/liquid interface region is a trailing edge of the meniscus.

9. A method of rinsing a surface with a low surface tension liquid comprising:
heating the low surface tension liquid to a temperature not more than 25 degrees C. less than boiling point of the low surface tension liquid;
delivering the heated low surface tension liquid to an air/liquid interface region; and
heating the air/liquid interface region to at least 2 degrees C. greater than the boiling point of the low surface tension liquid.

10. The method of claim 9, wherein the air/liquid interface region is on a surface of a wafer.

11. The method of claim 10, further comprising moving the air/liquid interface region across the surface of the wafer.

12. The method of claim 10, wherein heating the air/liquid interface region to at least 2 degrees C. greater than the boiling point of the low surface tension liquid includes heating at least one of a front surface and a back surface of the wafer.

13. The method of claim 10, wherein heating the air/liquid interface region to at least 2 degrees C. greater than the boiling point of the low surface tension liquid includes heating a front surface and a back surface of the wafer.

14. The method of claim 10, wherein delivering the heated low surface tension liquid to an air/liquid interface region includes submerging the wafer in a reservoir containing a quantity of the heated low surface tension liquid and wherein the air/liquid interface region is proximate to the surface of the quantity of the heated low surface tension liquid.

15. The method claim 10, wherein delivering the heated low surface tension liquid to an air/liquid interface region includes a nozzle directed toward the air/liquid interface region for spraying the heated low surface tension liquid on the surface of the wafer.

16. The method of claim 10, wherein delivering the heated low surface tension liquid to the air/liquid interface region includes forming a meniscus between a proximity head surface and a surface of the wafer wherein the air/liquid interface region is a trailing edge of the meniscus.

17. A system for processing and drying a wafer with a low surface tension liquid compromising:
a low surface tension liquid source including a first heat source capable of heating the low surface tension liquid to not more than 25 degrees C. less than boiling point of the low surface tension liquid;
a delivery mechanism for delivering the heated low surface tension liquid to an air/liquid interface region wherein the air/liquid interface region is on a surface of a wafer;
a second heat source directed toward the air/liquid interface region, the second heat source capable of heating the air/liquid interface region to at least 2 degrees C. greater than the boiling point of the low surface tension liquid, wherein the second heat source is directed to at least one of a front surface and a back surface of the wafer; and
an actuator capable of moving the air/liquid interface region across the surface of the wafer.
